(19) United States
(12) Patent Application Publication
(10) Pub. No.: US 2011/0036000 A1
(43) Pub. Date: Feb. 17, 2011

(54) Invertible Embedded Container System

(76) Inventor: Carl Verdecia, Fresh Meadows, NY (US)

Correspondence Address: JAY M. SCHLOFF, 6960 Orchard Lake Road, Suite 315, West Bloomfield, MI, 48322, US

(21) Appl. No.: 12/855,529

(22) Filed: Aug. 12, 2010

Related U.S. Application Data
(60) Provisional application No. 61/233,645, filed on Aug. 13, 2009.

(51) Int. Cl. A01G 5/00

(52) U.S. Cl. 47/41.1

(57) ABSTRACT

An invertible embedded container system comprises a base unit, a vase unit, and a flange unit. The base unit and vase unit include open sides, such that the vase unit is received within the open side of the base unit. Inverting the container system is accomplished by selectively placing the vase unit into the base unit with the open side or closed side of the vase unit facing up. The flange unit attaches to the vase unit and covers any space between the vase unit and base unit. A user may configure the container system in a closed orientation to prevent water and debris from entering the vase unit while system is not in use.

### CROSS REFERENCE TO RELATED APPLICATIONS

The present disclosure is a claims priority on the U.S. Provisional Patent Application Ser. No. 61/233,645, filed on Aug. 13, 2009, the disclosure of which is incorporated by reference.

### FIELD OF THE DISCLOSURE

The present disclosure relates generally to decorative displays erected at a gravesite, and more specifically, to a container system that may, while in use, receive floral or other arrangements, and while not in use, may be inverted and securely closed such that a seal is formed to prevent the container system from being filled with undesirable materials.

### BACKGROUND OF THE DISCLOSURE

It is customary to adorn a gravesite with a floral arrangement or other decorative item, either at a holiday time, birthday, or any other special occasion. Headstones and gravemarkers at gravesites often include an accommodation for holding or receiving a vase in an upright position, such that surviving family members or friends can place and display the floral arrangements or other decorative items in an organized and aesthetic fashion. However, surviving family members and friends may not always be present to maintain the gravesite with a floral arrangement or other decorative item in a presentable condition at all times however. Therefore, it is preferable to be able to maintain the gravesite in a safe and tidy state when the site is not regularly attended such that the vase will not accumulate water or debris and will not otherwise be exposed to elements that may damage it.

Furthermore, cemeteries may require that the gravesites be maintained in such a state that vases do not protrude upwardly from the ground during long unattended stretches, or at all times, including unattended stretches of time and when the vases are in use to display floral arrangements.

Various efforts have been made to provide for a vase that may sit flush with the ground in proximity to a grave site. U.S. Pat. No. 3,302,326 to Maino shows a reversible flower container that includes a vase that may be locked into place in a larger container for holding the vase flush with the ground. U.S. Pat. No. 3,233,367 to Hagle discloses an embedded cemetery flower container, which patent includes a vase and a larger container in which the vase may be securely received.

The prior art thus shows containers systems whereby a vase may be securely retained in a container such that the vase and container may be flush with a ground surface, but the prior art remains lacking in a number of regards. Notably, the aspects for securing a vase in a container in the prior art are unnecessarily complex. For instance, Maino shows a system of detents that require the user to align the vase particularly before the vase may be inserted into and secured within the larger container. Hagle shows a vase with rolled edges, which edges secure the vase within the larger container. At the base of Hagle's larger container is a leaf spring. The rolled edges and leaf spring arrangement necessarily require the use of a significant amount of force to retain or remove the vase from the container.

Accordingly, there exists a need for a tray system that overcomes all of the disadvantages of the prior art, while still retaining the advantages of the prior art.

### SUMMARY OF THE DISCLOSURE

In view of the foregoing disadvantages inherent in the prior art, the general purpose of the present disclosure is to provide an invertible embedded container system, configured to include all the advantages of the prior art, and to overcome the drawbacks inherent therein.

Accordingly, an object of the present disclosure is to provide an invertible embedded container system with a vase unit that may receive and display floral arrangements or other decorative items therein, and a base unit that may receive the vase unit therewithin, to secure the vase unit within the base unit. The base unit may be embedded in a surface, such as the ground in proximity to a gravesite or headstone, such that, when the vase unit is placed in the base unit, the vase unit may sit flush with the surface and not protrude above the surface. The system further comprises a flange unit for removable attachment to the vase unit.

In an embodiment of the present disclosure, the vase unit comprises an open end and a closed end, with engagement features on each end. The flange unit comprises complementary engagement features for removable attachment to either the open end or the closed end of the vase unit. Upon being attached to the vase unit, the flange unit may extend across the perimeter of the vase unit. The flange unit may be so sized and configured that, when it is attached to the vase unit, and the vase unit has been received by the base unit, the flange unit will also extend across the perimeter of the base unit to seal any space between the vase unit and the base unit. In a preferred embodiment, the engagement features of the vase unit and the flange unit comprise threaded regions.

These together with other aspects of the present disclosure, along with the various features of novelty that characterize the present disclosure, is pointed out with particularity in the claims annexed hereto and forms a part of this present disclosure. For a better understanding of the present disclosure, its operating advantages, and the specific objects attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates a perspective view of a vase unit and a base unit of an invertible embedded container system, in accordance with an embodiment of the present disclosure;

FIG. 2 illustrates a disassembled view of an invertible embedded container system, in accordance with an embodiment of the present disclosure;

FIG. 3 illustrates an assembled view of an invertible embedded container system, wherein the container system is in a open position, in accordance with an embodiment of the present disclosure; and

FIG. 4 illustrates an assembled view of an invertible embedded container system, wherein the container system is in a closed position, in accordance with an embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in composition, structure, and design. It should be emphasized, however, that the present disclosure is not limited to an invertible embedded container system as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

Unless limited otherwise, the terms “coupled,” “attached,” and variations thereof herein are used broadly and encompass direct and indirect arrangements. The terms “a” and “an” herein do not denote a limitation of quantity, but rather denote the presence of at least one of the referenced items.

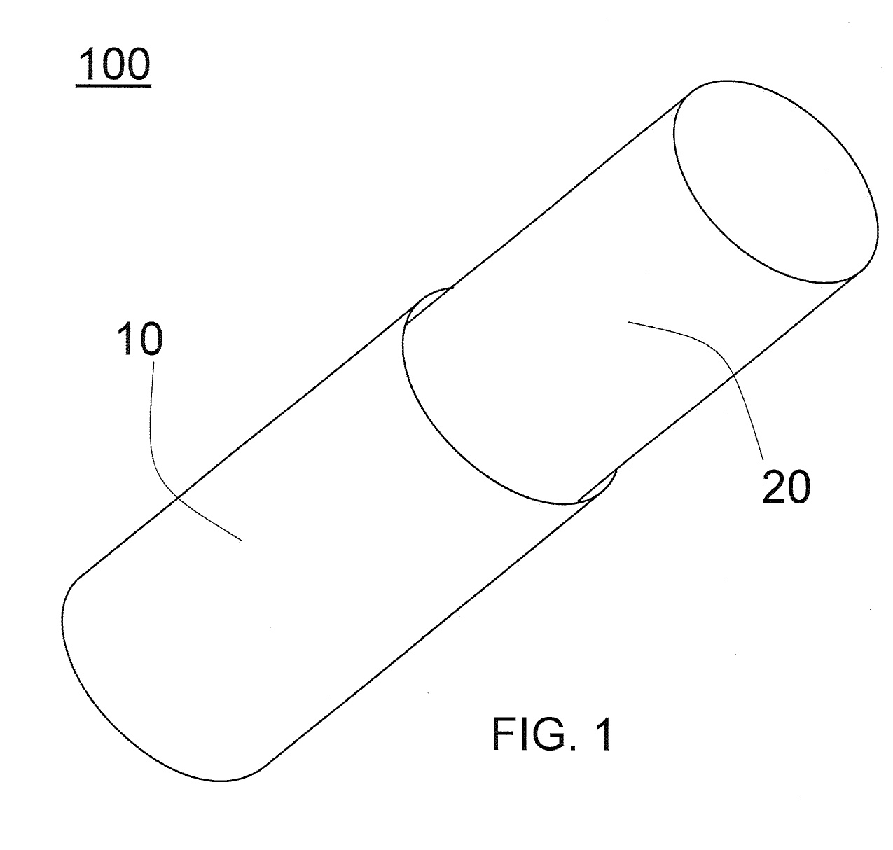

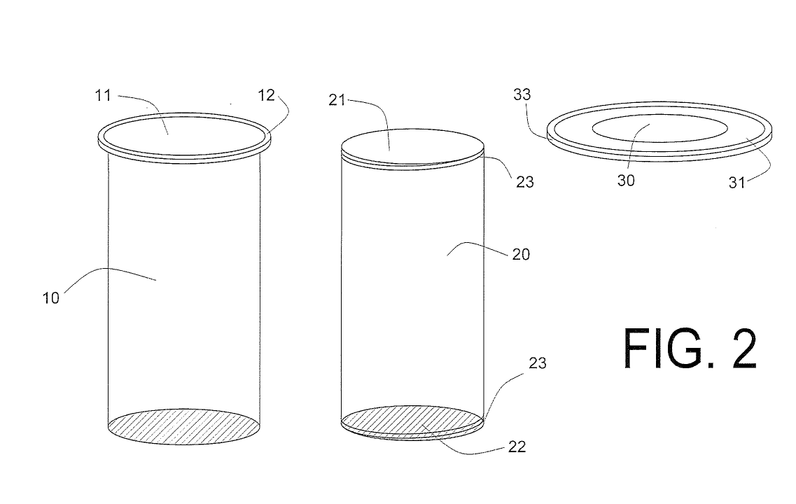

Referring now to FIG. 1 and FIG. 2, the present disclosure provides an invertible embedded container tray system 100. In an embodiment, the system comprises a base unit 10, a vase unit 20, and a flange unit 30. The base unit 10 receives the vase unit 20 therein, and the flange unit 30 attaches to the vase unit 20.

The base unit 10 may be in the shape of a cylinder, cube, or any other configuration that allows the base unit 10 to have an open side 11. The base unit 10 further comprises a lip 12, which lip 12 extends away from the open side 11 of the base unit 11. In a preferred embodiment, the lip 12 extends perpendicularly away from the open side 11 of the base unit 10, the lip 12 is disposed along the entire perimeter or circumference of the open side 11 of the base unit. In an embodiment, the base unit 10 may be conical, with the greater or greatest diameter being that of the open side 11. In such an embodiment, the taper of the conical configuration allows the base unit 10 to securely receive the vase unit 20 therewithin. The base unit 10 may further comprise at least one aperture along its closed sides, which at least one aperture may relieve any pressure that may otherwise accumulate between the base unit 10 and the vase unit 20.

The vase unit 20 of the present disclosure may also be in the shape of a cylinder, cube, or any other configuration that allows the vase unit 20 to have an open side 21. Opposite the open side 21 of the vase unit 20 will be a closed side 22. Proximate to the open side 21 and the closed side 22 of the vase unit 20 are be engagement features 23, which engagement features will be explained in further detail in connection with the flange unit 30. The engagement features 23 may be any engagement features known in the art that facilitate secure but removable attachment between the vase unit 20 and flange unit 30, and it will be apparent that the engagement features 23 of the vase unit 20 will be complementary to the engagement features 33 of the flange unit 30. In a preferred embodiment, the engagement features 23 of the vase unit 20 comprise threads disposed on the exterior circumference of the vase unit 20.

The flange unit 30 of the present disclosure comprises a substantially planar body 31, which body 31 extends from the vase unit 20 outwardly across any gap between the vase unit 20 and base unit 10 that may remain when the vase unit 20 is placed within the base unit 10. Engagement features 33 of the flange unit 30 are disposed on one side of the body 31, which engagement features 33 are complementary with the engagement features 23 of the vase unit 20. It will be apparent that the engagement features 33 of the flange unit 30, being disposed on only one side of the body 31 of the flange unit, will not protrude upwardly from a surface in which the container system is placed.

It will be understood that shape of the body 31 of the flange unit 30 will be dictated by the shapes of the base unit 10 and vase unit 20 so that the flange unit 30 may completely cover the space between the base unit 10 and vase unit 20. By way of example, in the case where the base unit 10 and vase unit 20 are cylindrical in shape, the shape of the body 31 of the flange unit will be circular.

The above-discussed components of the container system 100 may be produced in a variety of sizes as well as configurations. In an exemplary embodiment, the base unit 10 will be 12 inches in height and 6.5 inches in diameter at its open side 11.

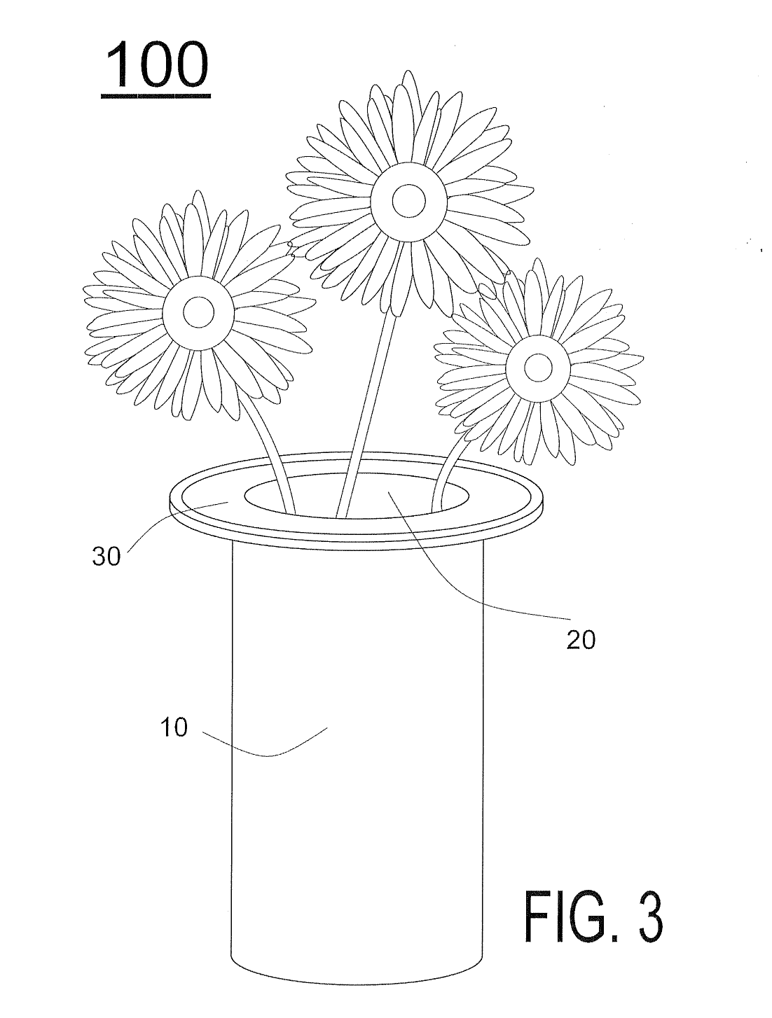

In use, and shown in FIG. 3, to display a floral arrangement or other item in the container system 100, the base unit 10 is placed (open side 11 up) into a surface, such as the ground. The base unit 10 is inserted into the surface to the extent that the lip 12 of the base unit 10 is flush with the surface. The vase unit 20 is thereafter placed within the base unit 10, with the open side 21 of the vase unit 20 facing up as well. The flange unit 30 is then fastened to the vase unit 20 by way of the complementary engagement features 23 and 33 of the vase unit 20 and flange unit 30.

In the preferred embodiment referenced above, the complementary engagement features are threads, the base unit 10 and vase unit 20 are cylindrical in shape, and the shape of the body 31 of the flange unit will be circular. As such, the flange unit 30 is fastened to the vase unit 20 by screwing the flange unit 30 onto the vase unit 20. When the flange unit 30 is so attached to the vase unit 20, the flange unit extends outwardly from the vase unit 20 far enough that it covers any space between the base unit 10 and vase unit 20. When the system 100 is so assembled, a user may place a floral arrangement or other decorative item in the vase unit 20 for display.

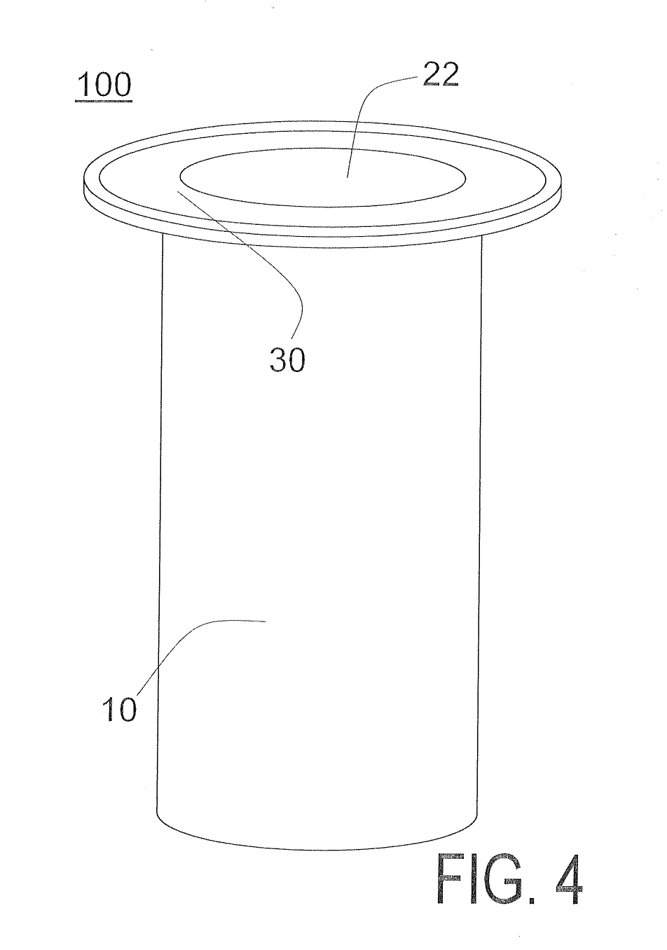

To configure the system 100 in its closed orientation, and as shown in FIG. 4, with the base unit 10 inserted into a surface, the vase unit 20 is placed into the base unit 10 with the open side 21 of the vase unit facing down and the closed side 22 of the vase unit facing up. The flange unit 30 is then fastened to the vase unit 20 by way of the complementary engagement features 23 and 33 of the vase unit 20 and flange unit 30. Referring again to the preferred embodiment above, the complementary engagement features are threads, the base unit 10 and vase unit 20 are cylindrical in shape, and the shape of the body 31 of the flange unit will be circular. As such, the flange unit 30 is fastened to the vase unit 20 by screwing the flange unit 30 onto the vase unit 20. When the flange unit 30 is so attached to the vase unit 20, the flange unit extends outwardly from the vase unit 20 far enough that it covers any space between the base unit 10 and vase unit 20.

When the system 100 is so assembled, with the closed side of the vase unit 20 facing up, and the flange unit 30 attached to the vase unit 20, a closure and a seal are formed so that exterior elements (such as rain and debris) cannot enter the container system 100, and the container system 100 is maintained in a clean and intact condition for the next instance that the user wishes to display an item or items in the container system 100.

The various components of the container system 100 should preferably comprise pliable, lightweight, non-corroding, and ultraviolet-resistant materials. In an embodiment, the base unit, vase unit, and flange unit comprise mid-weight plastic.

The invertible embedded container system disclosed herein is advantageous in allowing a gravesite to be maintained in a safe and tidy state when the site is not regularly attended in that the vase unit will not accumulate water or debris and will not otherwise be exposed to elements that may damage it. The system facilitates compliance with cemeteries' requirements that gravesites be maintained in such a state that vases do not protrude upwardly from the ground during long unattended stretches, or at all times, including unattended stretches of time and when the vases are in use to display floral arrangements.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. An invertible embedded container system, the system comprising a base unit, a vase unit, and a flange unit, wherein
the base unit comprises an open side and a plurality of closed sides,
the vase unit comprises an open side and a plurality of closed sides, and
the flange unit comprises a substantially planar body,
wherein the vase unit and flange unit have complementary engagement features disposed thereon, which engagement features allow the flange unit to irremovably and securely attach itself to the vase unit,
such that the vase unit is received within the base unit through the open side of the base unit, and the flange unit is removably attached to the vase unit and extends away from the vase unit to cover any space between the base unit and the vase unit.

2. The system of claim 1, wherein the engagement features of the flange unit extend away from the substantially planar body of the flange unit.

3. The system of claim 1, wherein the base unit is cylindrical in shape, the vase unit is cylindrical in shape, and the planar body of the flange unit is circular in shape.

4. The system of claim 1, wherein the complementary engagement features of the flange unit and vase unit comprise threads.

5. The system of claim 1, wherein the base unit is cuboidal in shape, the vase unit is cuboidal in shape, and the planar body of the flange unit is rectangular in shape.

6. The system of claim 1, wherein the complementary engagement features of the flange unit and vase unit comprise a snap-fit arrangement.

7. The system of claim 1, wherein the base unit, vase unit, and flange unit are comprised of midweight plastic.

8. The base unit of claim 1, wherein said base unit further comprises at least one aperture disposed on a closed side of said base unit.

9. An invertible embedded container comprising a base unit, a vase unit, and a flange unit, wherein
the base unit comprises an open side and a plurality of closed sides,
the vase unit comprises an open side and a plurality of closed sides, and
the flange unit comprises a substantially planar body,
wherein the vase unit and flange unit have complementary engagement features disposed thereon, which engagement features allow the flange unit to irremovably and securely attach itself to the vase unit,
such that the vase unit is received within the base unit through the open side of the base unit, and the flange unit is removably attached to the vase unit and extends away from the vase unit to cover any space between the base unit and the vase unit.
